(19) United States
(12) Patent Application Publication
(10) Pub. No.: US 2023/0343093 A1
(43) Pub. Date: Oct. 26, 2023

(54) RELATIVE ANCHORS BASED ON DENSITY OF FEATURE POINTS

(71) Applicant: International Business Machines Corporation, Armonk, NY (US)

(72) Inventors: Idan FRIEDMAN, Hibat Zion (IL); Ke ZHANG, Beijing (CN); Alessandro DONATELLI, Rome (IT)

(21) Appl. No.: 17/729,197

(22) Filed: Apr. 26, 2022

(51) Int. Cl. G06V 20/40; G06V 20/70; G06V 10/762; G06T 7/70

(52) U.S. Cl. CPC G06V 20/41; G06V 20/70; G06V 10/763; G06T 7/70

(57) ABSTRACT

An example system includes processor to receive a frame of video and a number of detected feature points for the frame. The processor can calculate a position of a relative anchor for the frame based on a density of the feature points. The processor can add the relative anchor to the frame. The processor can then transmit the frame with the added relative anchor to a second computing device.

### BACKGROUND

The present techniques relate to annotation of video frames. More specifically, the techniques relate to annotations of video frames in a three dimensional space.

ARCore and ARKit are example Augmented Reality (AR) frameworks for mobile devices. These frameworks are generally based on motion tracking, environmental understanding and light estimation. In particular, the frameworks use motion tracking and Simultaneous Localization and Mapping (SLAM) algorithms in order to understand and track phone positions relative to the world. Tracking phone position relative to the world is a common task in the AR world, and thus many AR applications may leverage these frameworks. The frameworks include an API for retrieving standard data, such as camera images, camera poses, point clouds, detected planes, among other data. However, these frameworks do not expose much of their internal logic and data, such as when coordinate system has been changed.

Moreover, one of the assumptions in such frameworks is that the three-dimensional (3D) data is relevant and true for the present frame only. For example, the model of the world may be continuously updated and adjusted according to additional acquired frames. For example, the 3D data may include a world coordinate space, camera position, point cloud, etc. As one example, such changes may include coordinate changes. For example, the documentation for the ARCore Android Software Development Kit (SDK) describes that “as ARCore's understanding of the environment changes, it adjusts its model of the world to keep things consistent.” Home, Products, ARCore, Reference, Concepts, High-Level ARCore concepts, Summary, World coordinate space. https://developers.google.com/ar/reference/c/group/concepts #world-coordinate-space. The ARCore Android SDK documentation continues that “when this happens, the numerical location (coordinates) of the camera and anchors can change significantly to maintain appropriate relative positions of the physical locations they represent.” Id. This assumption of correctness being limited to the current frame may force any processing to be made in real-time. In this regard, the ARCore Android SDK documentation describes the limitations associated with limited reliability of 3D data: “these changes mean that every frame should be considered to be in a completely unique world coordinate space.” Id. “The numerical coordinates of anchors and the camera should never be used outside the rendering frame during which they were retrieved.” Id. “If a position needs to be considered beyond the scope of a single rendering frame, either an anchor should be created or a position relative to a nearby existing anchor should be used.” Id.

However, processing in real-time may not be possible for asynchronous applications. For example, an asynchronous application may capture frame and 3D data in the present time and create a 3D annotation on a remote device at some time in the near future. Thus, asynchronous applications using existing phone position tracking algorithms may suffer from severe inaccuracies due to changes in the 3D data. For example, coordinate system changes in SLAM based systems may affects 3D annotation accuracy in Augmented Reality remote collaboration sessions. In particular, absolute 3D positions in world coordinate systems of such frameworks calculated from previous frames may not fit to a current world coordinate system. Therefore, any added annotations using absolute 3D positions may appear in a position that was not intended by the respective annotator.

Such technical problems may be addressed using solutions with a gallery/offline mode, in which experts use only most recent frames for annotation. However, the annotation process may take large amounts of time. For example, annotation may include placing, adding text, instruction numbering, coloring, etc. Moreover, coordinate system changes may occur frequently during this time, depending on scene dynamics. In addition, a region or points of interest might be out of view in the latest frames.

In some cases, avoid using expired data by detecting coordinate system changes. However, such solutions may result in bad user experience. In particular, changes to the coordinate system may happen during the annotation process of placing, adding text, instruction numbering, coloring, etc. Thus, the annotation process may have to be restarted using a newer valid frame every time a coordinate system change is detected.

In some cases, a real-time mode may be used in order to overcome these issues. For example, a real-time mode may include live video streaming from a technician to an expert. Both sides may thus share the same video. The expert adds annotations on the video. However, such solutions may require the technician to be very stable. In particular, the technician may not be able to point the camera in another region of interest, for example, to handle a previous task without causing problems. In addition, such real-time mode solutions may require high data bandwidth.

### SUMMARY

According to an embodiment described herein, a system can include processor to receive a frame of video and a number of detected feature points for the frame. The processor can also further calculate a position of a relative anchor for the frame based on a density of the feature points. The processor can also add the relative anchor to the frame. The processor can further transmit the frame with the added relative anchor to a second computing device.

According to another embodiment described herein, a method can include receiving, via a processor of a first device, a frame of video and a number of detected feature points for the frame. The method can further include calculating, via the processor, a position of relative anchor for the frame based on a density of the feature points. The method can also further include adding, via the processor, the relative anchor to the frame. The method can also include transmitting, via the processor, the frame with the added relative anchor to a second computing device.

According to another embodiment described herein, a computer program product for calculating anchors in frames can include computer-readable storage medium having program code embodied therewith. The computer readable storage medium is not a transitory signal per se. The program code executable by a processor to cause the processor to receive a frame of video and a number of detected feature points for the frame. The program code can also cause the processor to calculate a position of a relative anchor for the frame based on a density of the feature points. The program code can also cause the processor to add the relative anchor to the frame. The program code can also cause the processor to transmit the frame with the added relative anchor to a second computing device.

### BRIEF DESCRIPTION OF THE SEVERAL VIEWS OF THE DRAWINGS

FIG. 1 is a block diagram of an example system for annotation of a three dimensional scene using automatically generated relative anchors;

FIG. 2 is a process flow diagram of an example method that can generate relative anchors to be used for annotation of a set of frames;

FIG. 3 is a process flow diagram of an example method that can annotate frames of a scene using relative anchors;

FIG. 4A is a block diagram of an example computing device that can generate relative anchors for captured frames of a scene;

FIG. 4B is a block diagram of an example computing device that can annotate frames of a three dimensional scene using relative anchors;

FIG. 5 is a diagram of an example cloud computing environment according to embodiments described herein;

FIG. 6 is a diagram of an example abstraction model layers according to embodiments described herein;

FIG. 7A is an example tangible, non-transitory computer-readable medium that can generate relative anchors for captured frames of a three dimensional scene; and

FIG. 7B is an example tangible, non-transitory computer-readable medium that can annotate frames of a three dimensional scene using relative anchors.

### DETAILED DESCRIPTION

According to embodiments of the present disclosure, an example system includes processor to receive a frame of video and a number of detected feature points for the frame. The processor can calculate a position of a relative anchor for the frame based on a density of the feature points. As used herein, a relative anchor is an anchor generated for purposes of relative location of annotation. An anchor is a three dimensional (3D) location that is tracked a tracking system. The processor can add the relative anchor to the frame. The processor can then transmit the frame with the added relative anchor to a second computing device. Thus, embodiments of the present disclosure enable annotations to be accurately positioned in a three dimensional space associated with constantly updating 3D data. The embodiments thus provide for increased accuracy, with less restrictions on end users.

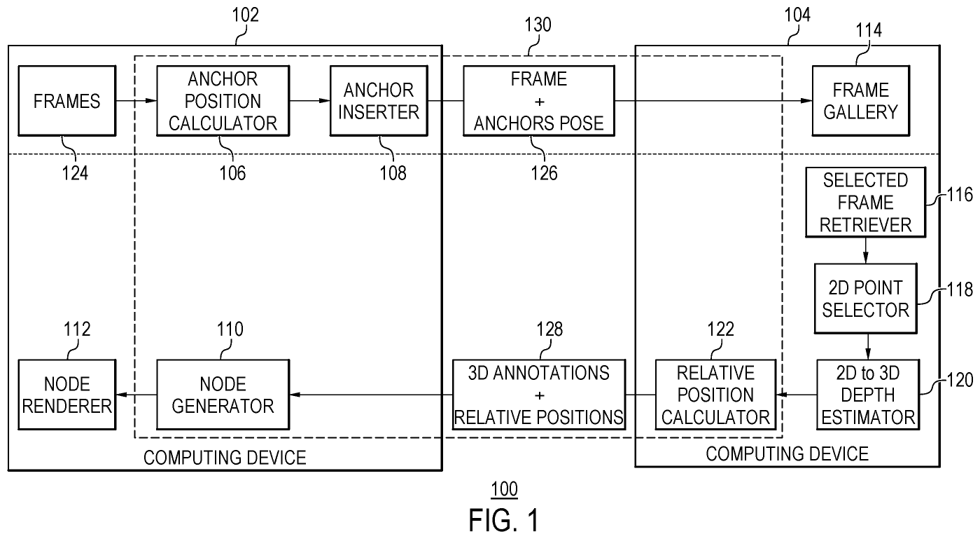

With reference now to FIG. 1, a block diagram shows an example system for annotation of a three dimensional scene using automatically generated relative anchors. The example system 100 of FIG. 1 includes a computing device 102. For example, the computing device 102 may be a device used by a technician, such as a mobile device with an augmented reality feature. The system 100 also includes another computing device 104 communicatively coupled to the computing device 102. For example, the computing device 104 may be a device used by an expert annotator, such as a laptop, workstation, or mobile device having an annotation application. The computing device 102 includes an anchor position calculator 106, an anchor inserter 108, a node generator 110, and a node renderer 112. The computing device 104 includes a frame gallery 114. For example, the frame gallery 114 may be a repository for frames received from the computing device 102. The computer device 104 further includes a selected frame retriever 116, a two dimensional (2D) point selector 118, a 2D to 3D depth estimator 120, and a relative position calculator 122. The computing device 102 further includes frames 124. For example, the frames may snapshots of a video stream captured by a camera (not shown) of the computing device 102 or attached to the computing device 102. The computing device 102 is shown generating frame and anchors pose 126 and receiving 3D annotations and relative positions 128 from the computing device 104. A dashed box indicates components of a relative anchoring subsystem 130.

In the example of FIG. 1, the computing device 102 may be a mobile device taking video of a scene in an environment. For example, the computing device 102 may be operated by a technician using an augmented reality application to receive input in the form of annotations 128 from an expert using another computing device 104, which may be a computing device in a different location. The computing device 102 thus receives frames 124 corresponding to the scene. For example, the frames 124 may be frames of video from a camera (not shown). In various example, the frames may also include three dimensional data, such as a camera position and a point cloud from a motion tracking system (not shown). For example, the camera position may be estimated by a tracking engine with visual inertial odometry (VIO) tracking. In various examples, the point cloud may include a number of detected features. In various example, the feature points may correspond to detected features in the frames, such as edges, corners, etc. For example, the feature points may be points in the point cloud from the motion tracking system. In various examples, the anchor position calculator 106 of the anchoring subsystem 130 calculates a position of relative anchors for the frames 124 based on a density of the feature points. For example, the anchor position calculator 106 may select anchor positions with a density model based on feature points from the point cloud. In some examples, the anchor position calculator 106 can use density based clustering for selecting positions. For example, the anchor position calculator 106 can use density-based spatial clustering of applications with noise (DBSCAN). In some examples, the anchor position calculator 106 can select a geometric median per cluster as a relative anchor position. For example, points in a dense area may be likely to be more distinguishable, textured, and stable.

Still referring to FIG. 1, the anchor inserter 108 can add the relative anchors to the scene. For example, the anchor inserter 108 can add the relative anchors to each of a number of frames to be sent to the computing device 104. In various examples, the anchor inserter 108 can add the relative anchors to the middle of the frames, assuming most cases user will select an object in that area. For example, the relative anchors may be added within a predetermined area of the frame. In some examples, the anchor inserter 108 can add the relative anchors in response to detecting that a frame does not have any associated relative anchors. The frame and relative anchors 130 may be sent along with the camera pose to the computing device 104. Thus, each of the frames 130 sent to the computing device 104 may include at least one relative anchor.

In various examples, the expert using the computing device 104 may then add one or more annotations to one or more of the frames and return the frames with the annotations positioned using relative anchors to the technician's computing device 102 for review. For example, the selected frame retriever 116 of computing device 104 may receive a selection of a frame from the frame gallery 114. The 2D point selector 118 may then receive a selected two-dimensional location for an annotation to be placed in the selected frame. The 2D to 3D depth estimator can perform a depth estimation from a point cloud.

The relative position calculator 122 of the computing device 104 may then calibrate the annotation positions based on their relative position to the pre-added relative anchors. For example, the relative position calculator 122 may calculate a relative position of each received annotation with respect to each of the relative anchors associated with the frame. In various examples, the relative position calculator 122 can calculate 3D relative positions of reach of the relative anchors.

The calculated relative positions along with 3D annotations 128 may then be sent to the computing device 102. The node generator 110 of the computing device 102 may receive the 3D annotations 128 and generate a node relative to any combination of selected relative anchors. In some examples, the node generator 110 may use voting to select a combination of relative anchors. For example, node generator 110 can calculate a 3D relative position to all valid relative anchors in current time and choose the majority location. Alternatively, in some embodiments, the node generator 110 can select a closest relative anchor. The node renderer 112 may then render the node. For example, the node may be displayed on a display (not shown) of the computing device 102. In various examples, the node may include a label with textual annotation information and a callout to a location of the annotation.

It is to be understood that the block diagram of FIG. 1 is not intended to indicate that the system 100 is to include all of the components shown in FIG. 1. Rather, the system 100 can include fewer or additional components not illustrated in FIG. 1 (e.g., additional computing devices, or additional frames, annotations, etc.).

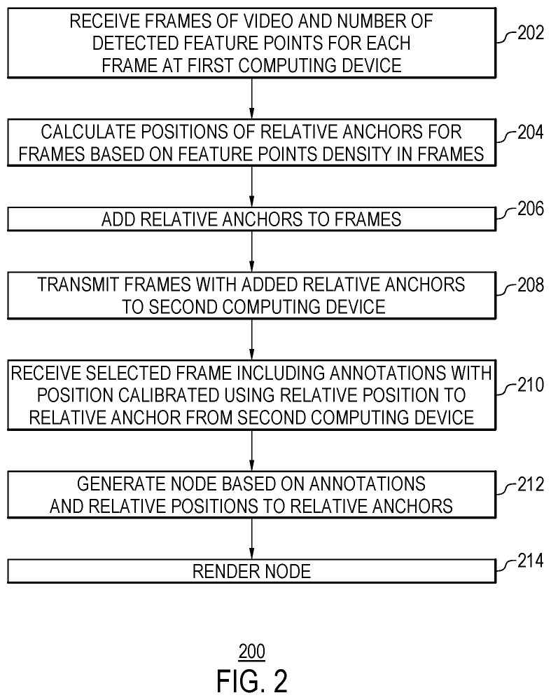

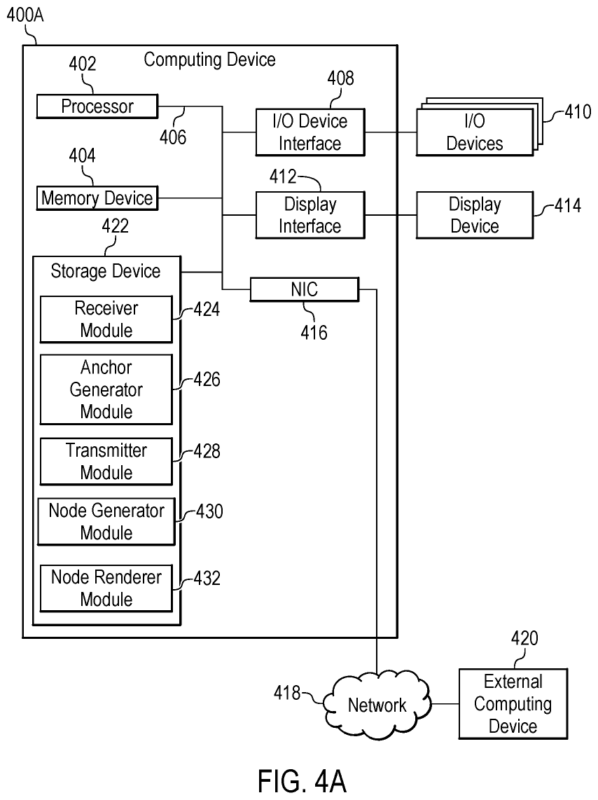

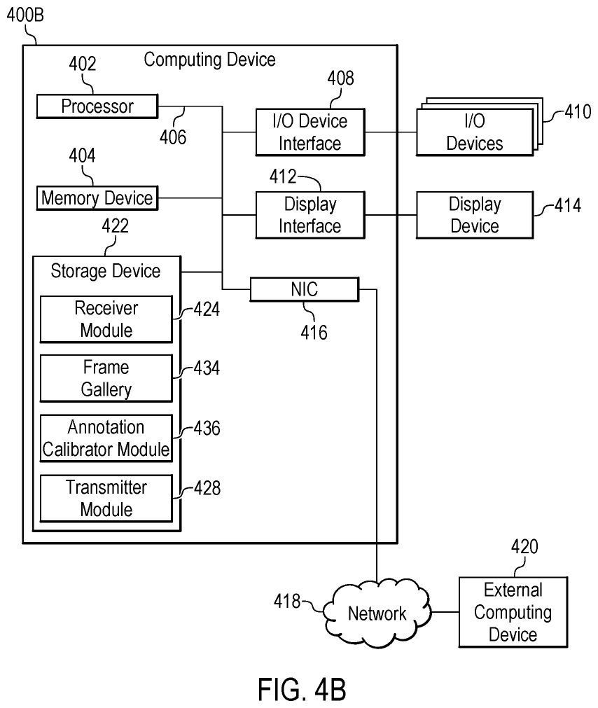

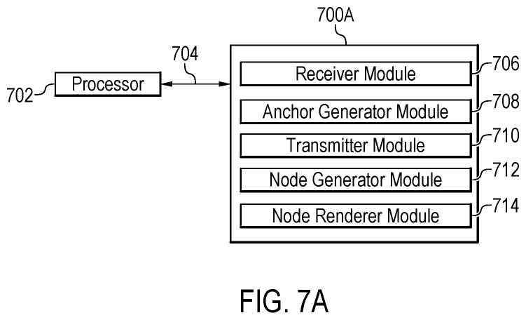

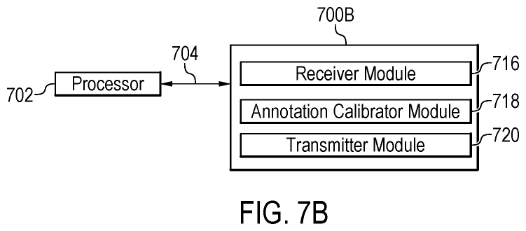

FIG. 2 is a process flow diagram of an example method that can generate relative anchors to be used for annotation of a set of frames. The method 200 can be implemented with any suitable computing device, such as the computing device 400A of FIG. 4A and is described with reference to the system 100 of FIG. 1. For example, the method described below can be implemented by the computing device 400A or using the computer-readable medium 700A of FIGS. 4A and 7A.

At block 202, a processor at a first computing device receives frames of video and a number of detected feature points for each frame. For example, the frames of video may be two-dimensional images that are snapshots of a video stream. In various examples, the detected feature points may be received from a motion tracking system. In various example, the processor may also receive a cam pose and a point cloud from the motion tracking system.

At block 204, the processor calculates a position of relative anchors for the frames based on a density of the feature points. For example, the processor can calculate the position of a relative anchor based on a density based clustering of the feature points. In some examples, the processor can calculate a position of the relative anchor based on a geometric median of a cluster. In various examples, the processor can calculate the position of the relative anchors within a predetermined region in a middle portion of the frame.

At block 206, the processor adds the relative anchors to the frames. For example, the relative anchors may be appended to each of the frames.

At block 208, the processor transmits the frame with the added relative anchors to a second computing device. For example, the frame may be transmitted using any suitable communication infrastructure, such as wireless or wired connections. In various example, the processor also transmits a camera pose to use as an absolute pose for calculating a relative pose.

At block 210, the processor receives a selected frame including annotations with positions calibrated using relative positions to the relative anchors from the second computing device. In various examples, the processor can select a relative anchor to use for generating a node.

At block 212, the processor generates a node based on an annotation and the relative position to the relative anchor. In various examples, the processor can select one of the number of calculated positions relative to a particular relative anchor for generating the node for each of the annotations.

At block 214, the processor renders the generated node. In various examples, the generated node may include a label with annotation information and a point indicating a location of the annotation in 3D space. For example, the node may be rendered in an augmented reality application.

The process flow diagram of FIG. 2 is not intended to indicate that the operations of the method 200 are to be executed in any particular order, or that all of the operations of the method 200 are to be included in every case. Additionally, the method 200 can include any suitable number of additional operations. For example, calculating the position of the relative anchor and generating the relative anchor may be executed in response to detecting that the frame is to be sent for annotation and does not include any relative anchor.

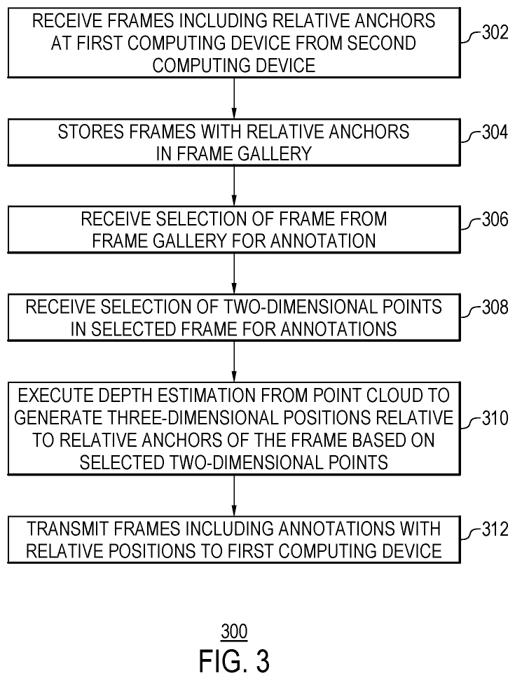

FIG. 3 is a process flow diagram of an example method that can annotate frames of a scene using relative anchors. The method 300 can be implemented with any suitable computing device, such as the computing device 400B of FIG. 4B and is described with reference to the system 100 of FIG. 1. For example, the methods described below can be implemented by the computing device 400B or using the computer-readable medium 700B of FIGS. 4B and 7B.

At block 302, a processor at a first computing device receives frames including relative anchors from a second computing device. In some examples, the frames may also include a camera pose. For example, the camera pose may be an absolute camera pose.

At block 304, the processor stores the frames with the relative anchors in a frame gallery. For example, the frame gallery may be a repository on the computing device 104 for storing frames.

At block 306, the processor receives a selection of a frame from the frame gallery for annotation. For example, the frame may be manually selected to be used for annotation.

At block 308, the processor receives a selection of two-dimensional points in the selected frame for annotations. For example, an annotator may have dragged and dropped an annotation onto the selected frame and the location point of the annotation may correspond to a two-dimensional point in the selected frame.

At block 310, the processor executes a depth estimation from a point cloud to generate three-dimensional positions relative to the relative anchors of the frame based on the selected two-dimensional points. For example, a relative pose for the annotation may be calculated from an absolute camera pose for each of the relative anchors, and a relative position for the selected two-dimensional points may be calculated for each of the relative anchors.

At block 312, the processor transmits frames including annotations with the relative positions to the first computing device. For example, the may be transmitted using any suitable communication infrastructure, which may include wireless or wired connections.

The process flow diagram of FIG. 3 is not intended to indicate that the operations of the method 300 are to be executed in any particular order, or that all of the operations of the method 300 are to be included in every case. Additionally, the method 300 can include any suitable number of additional operations.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

FIG. 4A is block diagram of an example computing device that can generate relative anchors for captured frames of a scene. The computing device 400A may be for example, a server, desktop computer, laptop computer, tablet computer, or smartphone. In some examples, computing device 400A may be a cloud computing node. Computing device 400A may be described in the general context of computer system executable instructions, such as program modules, being executed by a computer system. Generally, program modules may include routines, programs, objects, components, logic, data structures, and so on that perform particular tasks or implement particular abstract data types. Computing device 400A may be practiced in distributed cloud computing environments where tasks are performed by remote processing devices that are linked through a communications network. In a distributed cloud computing environment, program modules may be located in both local and remote computer system storage media including memory storage devices.

The computing device 400A may include a processor 402 that is to execute stored instructions, a memory device 404 to provide temporary memory space for operations of said instructions during operation. The processor can be a single-core processor, multi-core processor, computing cluster, or any number of other configurations. The memory 404 can include random access memory (RAM), read only memory, flash memory, or any other suitable memory systems.

The processor 402 may be connected through a system interconnect 406 (e.g., PCI®, PCI-Express®, etc.) to an input/output (I/O) device interface 408 adapted to connect the computing device 400 to one or more I/O devices 410. The I/O devices 410 may include, for example, a keyboard and a pointing device, wherein the pointing device may include a touchpad or a touchscreen, among others. The I/O devices 410 may be built-in components of the computing device 400, or may be devices that are externally connected to the computing device 400.

The processor 402 may also be linked through the system interconnect 406 to a display interface 412 adapted to connect the computing device 400 to a display device 414. The display device 414 may include a display screen that is a built-in component of the computing device 400. The display device 414 may also include a computer monitor, television, or projector, among others, that is externally connected to the computing device 400. In addition, a network interface controller (NIC) 416 may be adapted to connect the computing device 400 through the system interconnect 406 to the network 418. In some embodiments, the NIC 416 can transmit data using any suitable interface or protocol, such as the internet small computer system interface, among others. The network 418 may be a cellular network, a radio network, a wide area network (WAN), a local area network (LAN), or the Internet, among others. An external computing device 420 may connect to the computing device 400 through the network 418. In some examples, external computing device 420 may be an external webserver 420. In some examples, external computing device 420 may be a cloud computing node.

The processor 402 may also be linked through the system interconnect 406 to a storage device 422 that can include a hard drive, an optical drive, a USB flash drive, an array of drives, or any combinations thereof. In some examples, the storage device 422 may include a receiver module 424, an anchor generator module 426, a transmitter module 428, a node generator module 430, and a node renderer module 432. The receiver module 424 can receive frames of video and a number of detected feature points for each frame. For example, the frames may be received from the external computing device 420. The anchor generator module 426 can calculate a position of a relative anchor for the frame based on a density of the feature points. In some examples, the anchor generator module 426 can calculate the position of the relative anchor based on a density based clustering of the feature points. In various examples, the anchor generator module 426 can calculate the position of the relative anchor based on a geometric median of a cluster of the detected feature point. In some examples, the anchor generator module 426 can calculate the position of the relative anchor within a predetermined region in the middle of the frame. In various examples, the anchor generator module 426 can calculate the position of the relative anchor and generate the relative anchor in response to detecting that the frame is to be sent for annotation and does not include any relative anchor. The transmitter module 428 can transmit the frame with the added relative anchor to a second computing device. The node generator module 430 can receive a selected frame including an annotation with a position calibrated using relative position to the relative anchor position. The node generator module 430 can then generate a node based on the annotation and the relative position to the relative anchor. In some examples, the node generator module 430 may receive a selected frame including an annotation with a number of positions calculated using relative position to a number of relative anchors, and the processor can select one of the number of calculated positions for rendering the annotation. The node renderer module 432 can render the generated node. For example, the generated node may include a label with annotation information with a callout to a location of the annotation.

FIG. 4B is block diagram of an example computing device that can annotate frames of a three dimensional scene using relative anchors. For example, the computing device 400B may be used to annotate frames received from the computing device 400A of FIG. 4A. The computing device 400B may be for example, a server, desktop computer, laptop computer, tablet computer, or smartphone. In some examples, computing device 400B may be a cloud computing node. Computing device 400B may be described in the general context of computer system executable instructions, such as program modules, being executed by a computer system. Generally, program modules may include routines, programs, objects, components, logic, data structures, and so on that perform particular tasks or implement particular abstract data types. Computing device 400B may be practiced in distributed cloud computing environments where tasks are performed by remote processing devices that are linked through a communications network. In a distributed cloud computing environment, program modules may be located in both local and remote computer system storage media including memory storage devices.

The computing device 400B includes similarly referenced elements of the computing device 400A of FIG. 4A. For example, the storage device 422 includes a receiver module 424 that can receives frames including relative anchors from another computing device. For example, the frames may be received from the external computing device 420. The storage device 422 of computing device 400B further includes frame gallery 434 and an annotation calibrator module 436. In various examples, the receiver module 424 can store the frames with the relative anchors in the frame gallery 434. The annotation calibrator module 436 can receive a selection of a frame from the frame gallery for annotation. The annotation calibrator module 436 can also receive a selection of two-dimensional points in the selected frame for an annotation. The annotation calibrator module 436 can execute a depth estimation from a point cloud to generate three-dimensional positions relative to the relative anchors of the frame based on the selected two-dimensional points. The transmitter module 428 can then transmit frames including annotations with the relative positions to the external computing device 420.

It is to be understood that the block diagrams of FIGS. 4A and 4B are not intended to indicate that the computing devices 400A and 400B are to include all of the components shown in FIGS. 4A and 4B. Rather, the computing devices 400A and 400B can include fewer or additional components not illustrated in FIGS. 4A and 4B (e.g., additional memory components, embedded controllers, modules, additional network interfaces, etc.). Furthermore, any of the functionalities of the receiver module 424, the anchor generator module 426, the transmitter module 428, the node generator module 430, the node renderer module 432, and the annotation calibrator module 436, may be partially, or entirely, implemented in hardware and/or in the processor 402. For example, the functionality may be implemented with an application specific integrated circuit, logic implemented in an embedded controller, or in logic implemented in the processor 402, among others. In some embodiments, the functionalities of receiver module 424, the anchor generator module 426, the transmitter module 428, the node generator module 430, the node renderer module 432, and the annotation calibrator module 436 can be implemented with logic, wherein the logic, as referred to herein, can include any suitable hardware (e.g., a processor, among others), software (e.g., an application, among others), firmware, or any suitable combination of hardware, software, and firmware.

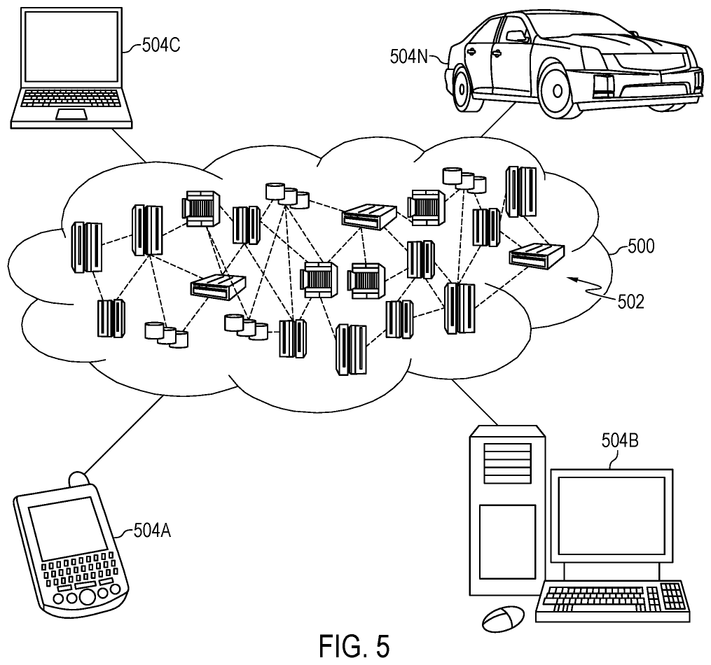

Referring now to FIG. 5, illustrative cloud computing environment 500 is depicted. As shown, cloud computing environment 500 includes one or more cloud computing nodes 502 with which local computing devices used by cloud consumers, such as, for example, personal digital assistant (PDA) or cellular telephone 504A, desktop computer 504B, laptop computer 504C, and/or automobile computer system 504N may communicate. Nodes 502 may communicate with one another. They may be grouped (not shown) physically or virtually, in one or more networks, such as Private, Community, Public, or Hybrid clouds as described hereinabove, or a combination thereof. This allows cloud computing environment 500 to offer infrastructure, platforms and/or software as services for which a cloud consumer does not need to maintain resources on a local computing device. It is understood that the types of computing devices 504A-N shown in FIG. 5 are intended to be illustrative only and that computing nodes 502 and cloud computing environment 500 can communicate with any type of computerized device over any type of network and/or network addressable connection (e.g., using a web browser).

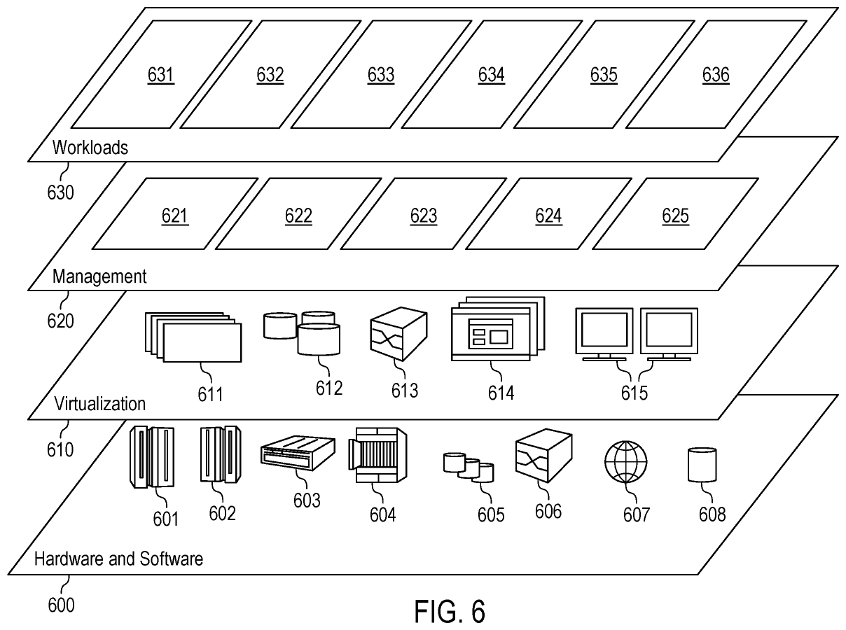

Referring now to FIG. 6, a set of functional abstraction layers provided by cloud computing environment 500 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 600 includes hardware and software components. Examples of hardware components include: mainframes 601; RISC (Reduced Instruction Set Computer) architecture based servers 602; servers 603; blade servers 604; storage devices 605; and networks and networking components 606. In some embodiments, software components include network application server software 607 and database software 608.

Virtualization layer 610 provides an abstraction layer from which the following examples of virtual entities may be provided: virtual servers 611; virtual storage 612; virtual networks 613, including virtual private networks; virtual applications and operating systems 614; and virtual clients 615.

In one example, management layer 620 may provide the functions described below. Resource provisioning 621 provides dynamic procurement of computing resources and other resources that are utilized to perform tasks within the cloud computing environment. Metering and Pricing 622 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 623 provides access to the cloud computing environment for consumers and system administrators. Service level management 624 provides cloud computing resource allocation and management such that required service levels are met. Service Level Agreement (SLA) planning and fulfillment 625 provide pre-arrangement for, and procurement of, cloud computing resources for which a future requirement is anticipated in accordance with an SLA.

Workloads layer 630 provides examples of functionality for which the cloud computing environment may be utilized. Examples of workloads and functions which may be provided from this layer include: mapping and navigation 631; software development and lifecycle management 632; virtual classroom education delivery 633; data analytics processing 634; transaction processing 635; and frame annotation processing 636.

The present invention may be a system, a method and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the techniques. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Referring now to FIG. 7A, a block diagram is depicted of an example tangible, non-transitory computer-readable medium 700A that can generate relative anchors for captured frames of a three dimensional scene. The tangible, non-transitory, computer-readable medium 700A may be accessed by a processor 702 over a computer interconnect 704. Furthermore, the tangible, non-transitory, computer-readable medium 700A may include code to direct the processor 702 to perform the operations of the method 200 of FIG. 2.

The various software components discussed herein may be stored on the tangible, non-transitory, computer-readable medium 700, as indicated in FIG. 7. For example, a receiver module 706 includes code to receive frames of video and a number of detected feature points for each frame. An anchor generator module 708 includes code to calculate a position of a relative anchor for the frames based on a density of the feature points. The anchor generator module 708 further includes code to add the relative anchor to the frames. The anchor generator module 708 also includes code to calculate the position of the relative anchor based on a density based clustering of the feature points. In some examples, the anchor generator module 708 also includes code to calculate the position of the relative anchor based on a density based clustering of the feature points. In some examples, the anchor generator module 708 also includes code to calculate the position of the relative anchor based on a geometric median of a cluster. In various examples, the anchor generator module 708 also includes code to calculate the position of the relative anchor within a predetermined region in the middle of the frame. A transmitter module 710 includes code to transmit the frame with the added relative anchor to a second computing device. The module 710 also includes code to transmit a camera pose associated with the frames. The receiver module 706 also includes code to receive a selected frame including an annotation with a position calibrated using relative position to the relative anchor position. A node generator module 712 includes code to generate a node based on the annotation and the relative position to the relative anchor. A node renderer module 714 includes code to render the generated node.

Referring now to FIG. 7B, a block diagram is depicted of an example tangible, non-transitory computer-readable medium 700B that can annotate frames of a three dimensional scene using relative anchors. The tangible, non-transitory, computer-readable medium 700B may be accessed by a processor 702 over a computer interconnect 704. Furthermore, the tangible, non-transitory, computer-readable medium 700B may include code to direct the processor 702 to perform the operations of the method 300 of FIG. 3.

The various software components discussed herein may be stored on the tangible, non-transitory, computer-readable medium 700, as indicated in FIG. 7. For example, a receiver module 716 includes code to receive frames including relative anchors. An annotator calibrator module 718 includes code to store the frames with the relative anchors in a frame gallery. The annotator calibrator module 718 further includes code to receive a selection of a frame from the frame gallery for annotation. The module 708 also includes code to receive a selection of two-dimensional points in the selected frame for an annotation. The module 708 also includes code to execute a depth estimation from a point cloud to generate three-dimensional positions relative to the relative anchors of the frame based on the selected two-dimensional points. A transmitter module 720 also includes code to transmit frames including annotations with the relative positions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. It is to be understood that any number of additional software components not shown in FIGS. 7A and 7B may be included within the tangible, non-transitory, computer-readable media 700A and 700B, depending on the specific application.

The descriptions of the various embodiments of the present techniques have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system, comprising a processor of a first computing device to:
receive a frame of video and a plurality of detected feature points for the frame;
calculate a position of a relative anchor for the frame based on a density of the feature points;
add the relative anchor to the frame; and
transmit the frame with the added relative anchor to a second computing device.

2. The system of claim 1, wherein the processor is to calculate the position of the relative anchor based on a density based clustering of the feature points.

3. The system of claim 1, wherein the processor is to calculate the position of the relative anchor based on a geometric median of a cluster of the detected feature points.

4. The system of claim 1, wherein the processor is to calculate the position of the relative anchor within a predetermined region in the middle of the frame.

5. The system of claim 1, wherein the processor is to receive a selected frame comprising an annotation with a position calibrated using relative position to the relative anchor position.

6. The system of claim 1, wherein the processor is to receive a selected frame comprising an annotation with a plurality of positions calculated using relative position to a plurality of relative anchors comprising the relative anchor, and the processor is to select one of the plurality of calculated positions for rendering the annotation.

7. The system of claim 1, wherein the processor is to calculate the position of the relative anchor and generate the relative anchor in response to detecting that the frame is to be sent for annotation and does not include any relative anchor.

8. A computer-implemented method, comprising:
receiving, via a processor of a first device, a frame of video and a plurality of detected feature points for the frame;
calculating, via the processor, a position of relative anchor for the frame based on a density of the feature points;
adding, via the processor, the relative anchor to the frame; and
transmitting, via the processor, the frame with the added relative anchor to a second computing device.

9. The computer-implemented method of claim 8, wherein calculating the position of the relative anchor is based on a density based clustering of the feature points.

10. The computer-implemented method of claim 8, wherein calculating the position of the relative anchor is based on a geometric median of a cluster.

11. The computer-implemented method of claim 8, wherein the position of the relative anchor is calculated within a predetermined region in a middle portion of the frame.

12. The computer-implemented method of claim 8, comprising receiving, via the processor, a selected frame comprising an annotation with a position calibrated using relative position to the relative anchor position.

13. The computer-implemented method of claim 8, comprising receiving, via the processor, a selected frame comprising an annotation with a plurality of positions calculated using relative position to a plurality of relative anchors comprising the relative anchor, and selecting, via the processor, one of the plurality of calculated positions for generating a node.

14. The computer-implemented method of claim 8, wherein calculating the position of the relative anchor and generating the relative anchor is executed in response to detecting that the frame is to be sent for annotation and does not include any relative anchor.

15. The computer-implemented method of claim 8, comprising generating a node based on the annotation and the relative position to the relative anchor and rendering the generated node.

16. A computer program product for calculating anchors in frames, the computer program product comprising a computer-readable storage medium having program code embodied therewith, wherein the computer-readable storage medium is not a transitory signal per se, the program code executable by a processor to cause the processor to:
receive a frame of video and a plurality of detected feature points for the frame;
calculate a position of a relative anchor for the frame based on a density of the feature points;
add the relative anchor to the frame; and
transmit the frame with the added relative anchor to a second computing device.

16. (canceled)

17. The computer program product of claim 16, further comprising program code executable by the processor to calculate the position of the relative anchor based on a density based clustering of the feature points.

18. The computer program product of claim 16, further comprising program code executable by the processor to calculate the position of the relative anchor based on a geometric median of a cluster.

19. The computer program product of claim 16, further comprising program code executable by the processor to calculate the position of the relative anchor within a predetermined region in the middle of the frame.

20. The computer program product of claim 16, further comprising program code executable by the processor to:
receive a selected frame comprising an annotation with a position calibrated using relative position to the relative anchor position;
generate a node based on the annotation and the relative position to the relative anchor; and
render the generated node.
